(19) United States
(12) Patent Application Publication
(10) Pub. No.: US 2022/0403747 A1
(43) Pub. Date: Dec. 22, 2022

(54) DEVICE AND METHOD FOR MACHINING A FAN BLADE

(71) Applicants: SAFRAN AIRCRAFT ENGINES, Paris (FR); CENTRE NATIONAL DE LA RECHERCHE SCIENTIFIQUE, Paris (FR); UNIVERSITE PAUL SABATIER - TOULOUSE III, Toulouse (FR)

(72) Inventors: Mathieu Julien CHARLAS, Moissy-Cramayel (FR); Damien Bruno LAMOUCHE, Moissy-Cramayel (FR); Redouane ZITOUNE, Ramonville-Saint-Agne (FR)

(73) Assignees: SAFRAN AIRCRAFT ENGINES, Paris (FR); CENTRE NATIONAL DE LA RECHERCHE SCIENTIFIQUE, Paris (FR); UNIVERSITE PAUL SABATIER - TOULOUSE III, Toulouse (FR)

(21) Appl. No.: 17/756,228

(22) PCT Filed: Nov. 16, 2020
(86) PCT No.: PCT/FR2020/052086

§ 371 Date: May 19, 2022

(30) Foreign Application Priority Data
Nov. 20, 2019 (FR) FR1912950

(51) Int. Cl. F01D 5/28; B24C 1/04

(52) U.S. Cl. CPC F01D 5/28; B24C 1/045; F05D 2220/323; F05D 2230/10; F05D 2240/30

(57) ABSTRACT

A method for removing a component fixed to an aeronautical part, the aeronautical part comprising a first material, and the component comprising a second material different from the first material, the method comprising steps of determining the thicknesses of the component as a function of the position on the component, and of removing the component by means of a pressurized water jet moving over the component as a function of the thicknesses determined in the determination step.

### TECHNICAL FIELD

The present invention relates to the field of aeronautical turbomachines, and more specifically the repair or the rework of turbomachine fan blades, and in particular a method and a device for removing material from the surface of these blades.

### PRIOR ART

In fields such as aeronautics, airplane weight reduction is a constant concern for manufacturers. For example, in aircraft engines, it is known to replace some metal blades with blades made of composite material, which have the advantage of being lighter.

Although these materials have generally very favorable mechanical qualities, particularly in relation to their mass, they have a certain sensitivity to point impacts.

In the case of fan blades, for example, made of an organic matrix composite, a metal leading edge, allowing increased resistance to point impacts to which this portion of the blades is subjected, is added to the end of the these blades. These metal leading edges act as shields taking for example the form of a thin intrados fin and a thin extrados fin joined at an upstream end of the blade, the whole conforming to the shape of the blade on the leading edge and the adjacent sections of the intrados and the extrados.

However, the accumulation of flight hours and the potential repeated impacts of foreign bodies generate wear on these metal leading edges, requiring their repair or their replacement.

There are different solutions for removing the metal leading edge from the rest of the blade, such as mechanical or thermomechanical tearing. These solutions nevertheless have the drawback of damaging the fibers of the composite material of the blade on which the leading edge is fixed. Conventional machining solutions can also be envisaged, but require complex computer tools and devices, in particular due to the warped and complex shape of the surface of the blades.

There is therefore a need for a material removal method that overcomes the drawbacks mentioned above.

### DISCLOSURE OF THE INVENTION

The present disclosure relates to a method for removing a component fixed to an aeronautical part, the aeronautical part comprising a first material, and the component comprising a second material different from the first material, the method comprising steps of:
Determining the thicknesses of the component as a function of the position on the component,
Removing the component by means of a pressurized water jet moving over the component, as a function of the thicknesses determined in the determination step.

It is understood that the component is a different element from the aeronautical part and is added to the latter, by being fixed thereto. The determination step allows mapping the thicknesses of the component. In other words, this step allows determining the thickness of the component for a given position on the outer surface of the component. This step thus allows determining the thickness of material to be removed.

The removal step allows removing the component by means of a pressurized water jet. The high pressure of the water jet acts as a machining tool, allowing the removal of the material contained in the component. For a given position on the surface of the component, the water jet thus removes the component material thickness determined in the determination step.

The use of the pressurized water jet, knowing the thickness of material to be removed, allows removing the component from the aeronautical part, without this aeronautical part being impacted. In other words, this method allows removing the first material contained in the component, while limiting direct contacts, as could be the case with a mechanical machining tool, with the second material contained in the aeronautical part. It is thus possible to spare the aeronautical part, by limiting the risks of degradation of the second material. The use of a pressurized water jet also has the advantage of simplifying the methods for removing material on parts having surfaces of complex shapes.

In some embodiments, the first material is an organic matrix composite, and the second material is a metal.

In other words, the aeronautical part includes an organic matrix composite, and the component fixed to the aeronautical part includes a metal. The method allows removing the metal from the component, without damaging the organic matrix composite, in particular without damaging the fibers of said composite.

In some embodiments, before the removal of the component, the component is fixed to the aeronautical part by bonding.

“Before the removal of the component” means before the execution of the method that is to say before the removal of the component, for example for replacement in case of wear of the component, is necessary. The component can be fixed to the aeronautical part by a structural epoxy adhesive, for example. Such a fixing method would risk, in case of removal of the component by mechanical tearing for example, damaging the fibers of the composite material of the aeronautical part. The use of the pressurized water jet allows overcoming this drawback.

In some embodiments, the pressure of the water jet is comprised between 100 and 1,000 bars.

This range of pressure values allows efficient removal of the component.

In some embodiments, the injected water includes an abrasive media.

The pressure of the used water jet, combined with the presence of the abrasive media, generates a multitude of impacts on the component, these impacts causing the withdrawal of particles of the second material, in particular the metal, contained in the component. The presence of the abrasive media thus allows improving the efficiency of the component removal method.

In some embodiments, the abrasive media has a grain size comprised between 50 μm and 1 mm.

The abrasive media can include solid particles present in the water intended to be injected under pressure, the diameter of these particles being comprised between 50 μm and 1 mm. Values below 50 μm would limit the efficiency of the removal method, and values above 1 mm would not be compatible with the pressurized water injection tool used within the framework of this method.

In some embodiments, the abrasive media is a sand comprising one among pure silica and silicon carbide.

In some embodiments, the water jet is applied by means of a nozzle oriented so as to form an angle comprised between +/−15° and +/−25°, preferably equal to +/−20° relative to a normal to a plane tangent to the surface of the component at a point on which the water jet is applied.

In case the component is a planar plate, for example, the nozzle, and consequently the pressurized water jet applied on the plate, has an angle comprised between +/−15° and +/−25°, for example an angle of +/−20°, relative to a direction perpendicular to this plate. This inclination of the water jet allows optimizing the removal of material of the component, compared to a situation in which the water jet would be oriented perpendicularly to the plate.

In some embodiments, the nozzle applying the water jet is disposed at a distance less than or equal to 20 cm from the component.

It is thus possible to avoid direct contact of the removal device with the aeronautical part. In addition, a distance greater than twenty centimeters would generate a dispersed water jet, and therefore a loss of accuracy of the latter during the removal step.

In some embodiments, the determination of the thicknesses of the component as a function of the position on the component is performed via ultrasound.

A scan of the entire external surface of the component can for example be performed using a tool that emits ultrasound. At each position of the tool on the surface of the component, a signal transmitted by the tool emitting ultrasound is converted into thickness. This ultrasound analysis can in particular be performed by echolocation.

During the use of the aeronautical part, the wear generated on the component is not uniform, such that the thickness of the component, at the time of removal of the latter, is itself not uniform. The determination of the thicknesses of the component, as a function of the position on the latter, via ultrasound, thus allows knowing the thickness of material to be removed for each of these positions, and thus adapting the pressurized water jet as a function of the thickness to be removed, for example by adapting the pressure of the water jet.

In some embodiments, during the removal step, the speed of displacement of the water jet moving over the component is constant, and the pressure of the water jet varies as a function of the thickness to be removed.

According to this configuration, the component thicknesses determined in the determination step are converted into pressures. During the displacement at constant speed of the water jet on the outer surface of the component, when the thickness of the component is locally lower, for example, the pressure is then reduced. Conversely, when the thickness is locally greater, the pressure of the water jet is increased. This removal method has the advantage of being able to be carried out by varying only one parameter, here the pressure, and thus of simplifying the control of the machining.

In some embodiments, during the removal step, the speed of displacement of the water jet moving over the component varies as a function of the thickness to be removed, the pressure of said water jet being constant.

According to this configuration, the component thicknesses determined in the determination step are converted into speeds. During the displacement at constant pressure of the water jet on the outer surface of the component, when the thickness of the component is locally lower, for example, the speed of displacement is then increased. Conversely, when the thickness is locally greater, the speed of displacement of the water jet is reduced, so that the water jet has time to remove the entire thickness of the component at this location. This removal method has the advantage of being able to be carried out by varying only one parameter, here the speed, and thus simplifying the control of the machining.

In some embodiments, during the removal step, the speed of displacement and the pressure of the water jet moving over the component vary as a function of the thickness to be removed.

According to this configuration, the thicknesses of the component determined in the determination step are converted into pairs of speed/pressure parameters.

In some embodiments, during the removal step, the speed of displacement and the pressure of the water jet moving over the component are constant, and the number of passages of the water jet varies as a function of the thickness to be removed.

Under this configuration, the component thicknesses determined in the determination step are converted into number of required passages of the water jet at a given position, as a function of the thickness at that position. For example, at constant speed and pressure, a greater thickness at a given location will result in a greater number of required passages at this location, and vice versa.

In some embodiments, a suction tool sucks the material removed during the removal step.

The device can be disposed in the vicinity of the water jet injection nozzle, for example less than 10 cm. The suction tool allows sucking the component material debris removed by the water jet during the removal step.

In some embodiments, the water jet moves over the component by means of an articulating tool comprising at least two axes of rotation.

In some embodiments, the water jet moves over the component by means of an articulating tool comprising only two axes of rotation.

The articulating tool can be a robot comprising at least two arms articulated relative to each other, the nozzle injecting the water jet being disposed at one end of one of the arms. The rotation of the nozzle about two axes of rotation only, by means of the articulating tool, has the advantage of simplifying the removal method, particularly for parts having a complex surface. In the case of warped surfaces for example, a mechanical machining tool would require rotations about five different axes in order to adapt to this warped shape, and to the variable thickness of the component. The use of the pressurized water jet allows limiting the number of necessary axes of rotation, and thus simplifying the removal method.

In some embodiments, the method comprises, after the removal step, a step of polishing the aeronautical part resulting from the removal step.

The polishing step can include the manual or mechanized sanding of residual glue after the removal step. This step allows standardizing and smoothing the surface of the resulting aeronautical part, on which the component which was fixed has been removed, in order to obtain a level of roughness close to that of a new part. This makes it in particular easier to fix a new component to the aeronautical part.

In some embodiments, the aeronautical part is a fan blade, and the component is the leading edge of the blade.

The method allows determining the thicknesses of the metal leading edge as a function of the position on the leading edge, then removing the leading edge by means of the pressurized water jet, by sparing the fan blade on which the leading edge is fixed, that is to say by limiting the risks of damaging the fibers of the organic matrix composite contained in the blade. In addition, the implementation of this method using a water jet oriented using a two-axis robot which scans the surface of the leading edge is particularly adapted to the warped shape of the fan blades.

The present disclosure also relates to a device for removing a component fixed to an aeronautical part, the aeronautical part comprising a first material, and the component comprising a second material different from the first material, the removal device comprising a measuring tool configured to measure the thickness of the component as a function of the position on the component, and a pressurized water injection tool configured to remove the component by means of the pressurized water jet moving over the component, as a function of the thicknesses determined by the measuring tool.

### BRIEF DESCRIPTION OF THE DRAWINGS

The invention and its advantages will be better understood upon reading the following detailed description of different embodiments of the invention given by way of non-limiting examples. This description refers to the pages of appended figures, on which:

FIG. 1 is a schematic perspective view of a turbofan engine,

FIG. 2 is a schematic perspective view of a rotating blade of the fan of the turbojet engine of FIG. 1,

FIG. 3 is a cross-sectional view, along the plane III-III, of the blade of FIG. 2,

FIG. 4 is a schematic view of the removal device according to one embodiment,

FIG. 5 is a detailed schematic view of a removal step by means of the device of FIG. 4,

FIG. 6 is a cross-sectional view of the blade of FIG. 4,

FIG. 7 is a diagram representing the removal method according to the present disclosure.

### DESCRIPTION OF THE EMBODIMENTS

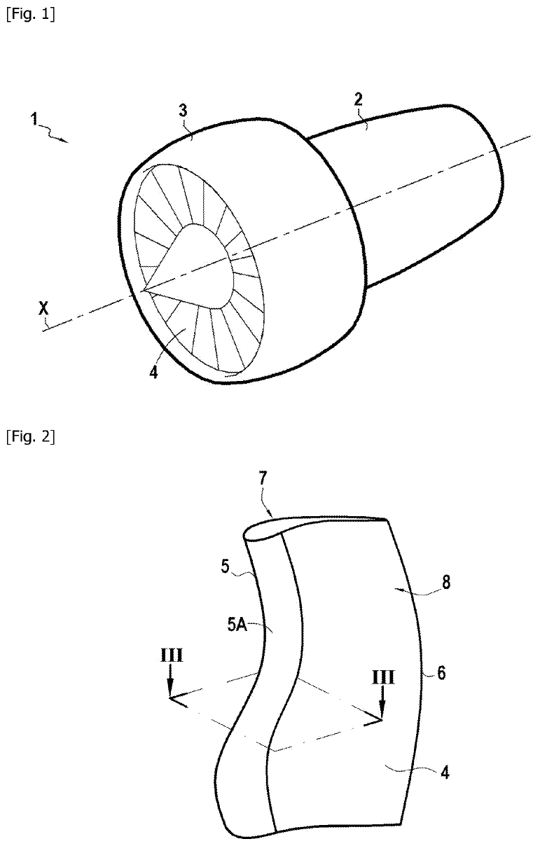

FIG. 1 illustrates a turbofan engine 1 comprising a gas generator unit 2 and a fan 3. This fan 3 comprises a plurality of rotating blades 4, arranged radially about a central axis X, and profiled aerodynamically so as to impel the air through their rotation. Thus, as illustrated in FIG. 2, each blade 4 has a leading edge, a trailing edge 6, an extrados 7 and an intrados 8.

In normal operation, the relative wind is substantially oriented towards the upstream end, along the flow direction of air in the fan, of each blade 4. This upstream end is particularly exposed to impacts and wear. Particularly when the blade 4 comprises a composite material, in particular with a fiber-reinforced polymer matrix, it is therefore necessary to protect this upstream end of the blade 4 with a leading edge 5 fixed to each blade 4.

The leading edge 5 is a part, or component, added on the upstream end of the blade 4, along the flow direction of air in the fan, and conforming to the shape of the upstream end of the blade 4. In other words, the leading edge 5 is assembled on the blade 4. This assembly can be performed by bonding, by a structural epoxy adhesive for example. The leading edge 5 is made of a material having better resistance to point impacts than the composite material of the blade 4. More specifically, the leading edge 5 is mainly metallic, and more specifically made of titanium-based alloy, such as TA6V (Ti-6Al-4V). The leading edge 5 could also be made of steel or iron, chromium and nickel based alloy such as Inconels®.

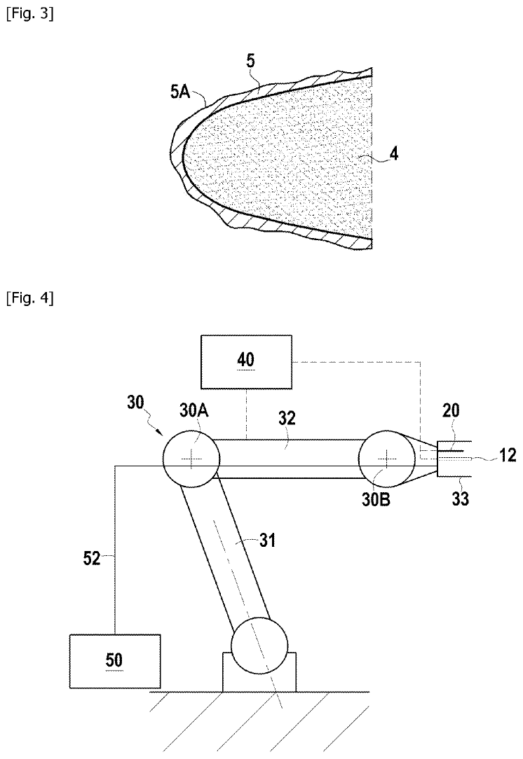

The outer surface 5A of the leading edge 5 is thus exposed to impacts and wear, consequently protecting the composite material of the blade 4. The accumulation of flight hours causes wear of this leading edge. This wear, and the impacts causing this wear not being uniform, the thickness of the leading edge 5A is itself non-uniform. FIG. 3 is a cross-sectional view, along the plane III-III, of the blade of FIG. 2, and illustrates an example of variations in the thickness of the leading edge 5 as a function of the position on the outer surface 5A of the leading edge 5.

When the wear of this leading edge 5 is significant, it is necessary to remove the latter, in order to replace it with a new leading edge. This removal is possible by means of a removal device described below with reference to FIG. 4, and comprising an articulating tool 30, for example a robot, the articulating tool 30 comprising at least a first arm 31 fixed to the ground for example, at least a second arm 32 articulated relative to the first arm 31 by means of a first axis of rotation 30A, and a tool holder 33 articulated relative to the second arm 32 by means of a second axis of rotation 30B.

The removal device also comprises a control unit 40 connected to the articulating tool 30, and controlling the movements of the latter. A measuring tool 20 can be fixed on the tool holder 33, and is configured to detect the thicknesses of the leading edge 5. The measuring tool 20 can be an ultrasonic thickness gauge. The measuring tool 20 is connected to the control unit 40. The control unit 40 can be a man-machine interface capable of translating geometrical paths in space into machine code line to control the arms of the articulating tool 30.

The removal device also comprises a pressurized water injection tool 10. The pressurized water injection tool comprises a high-pressure pump (not represented), and an injection nozzle 12, connected to the pump. The pressurized water injection tool 10 is configured to inject a trickle of water, by means of the injection nozzle 12, at a pressure comprised between 100 and 1,000 bars. The water present in the pump and intended to be injected by the injection nozzle 12 can be mixed with an abrasive media, having a grain size comprised between 50 μm and 1 mm. The abrasive media can be pure silica or silicon carbide. The water injection tool 10 is connected to the control unit 40. The control unit 40 can thus regulate the pressure of the water injected by the water injection tool 10.

The water injection nozzle 12 and the measuring tool 20 can be fixed simultaneously to the tool holder 33. Alternatively, the water injection nozzle 12 and the measuring tool 20 can be fixed successively to the tool holder 33. More specifically, at the end of the first step of the method described below, the measuring tool 20 can be removed from the tool holder 33 and replaced with the water injection nozzle 12, for the execution of the second step.

The removal device can also include a suction tool 50 comprising a suction duct 52, one end of which is fixed to the tool holder 33, in the vicinity of the injection nozzle 12. The suction tool 50 can be a suction device configured to suck debris and liquid, and having a power comprised between 1,500 and 2,500 W.

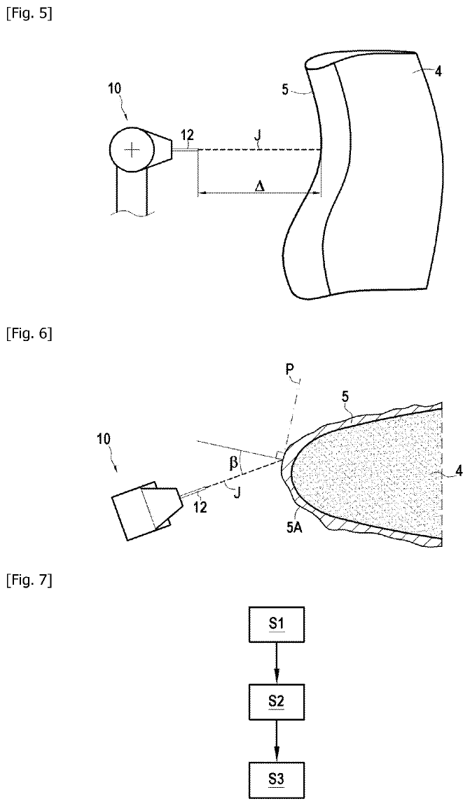

The removal method is described in the following description, with reference to FIGS. 5 to 7.

A first step (step S1) allows determining the thickness of the leading edge 5 as a function of the position on the latter, that is to say for a given point of the outer surface 5A of the leading edge 5.

During step S1, the control unit 40 controls the articulating tool 30 such that the measuring tool 20, disposed opposite the leading edge 5, moves by scanning the entire outer surface 5A of the leading edge 5 along a predetermined path, by emitting ultrasound. The data measured by the measuring tool 20 are then transmitted to the control unit 40, which converts these data into thicknesses. Thus, at the end of step S1, the mapping of the thicknesses of the leading edge 5, that is to say the thickness of the leading edge for each given point on the outer surface 5A, is known.

A second step (step S2) allows removing the leading edge 5 of the blade 4. To do so, the control unit 40 converts the thicknesses measured during the first step S1, into pressures. The control unit 40 then controls the articulating tool 30 such that the water injection nozzle 12, disposed opposite the leading edge 5, moves by scanning the entire outer surface 5A of the leading edge 5 following the same path as the measuring tool 20 during step S1. During this scanning, the injection nozzle 12, disposed on the tool holder 33, moves at a constant speed v0, and the pressure p of water injected by the nozzle 12 varies as a function of the thickness of the leading edge 5, based on the conversion performed by the control unit 40.

In parallel with this removal step, the debris or particles of the leading edge 5 removed by the water jet J can be sucked by the suction tool 50, by means of the suction duct 52 also disposed on the tool holder 33. Alternatively, the suction of the debris can be performed at the end of step S2.

During step S2, in order to improve the accuracy of the machining by avoiding excessive dispersion of the water jet J, a distance Δ between the end of the nozzle 12 and each point of contact between the jet J and the outer surface 5A of the leading edge 5, remains less than or equal to 20 cm, during the displacement of the nozzle 12.

Furthermore, an angle β between the jet J and a straight line perpendicular to the plane P tangent to the outer surface 5A at the point of contact between the jet J and the surface 5A, and passing through this point of contact, is comprised between +/−15° and +/−25°.

In addition, during step S2, the scanning of the outer surface 5A of the leading edge 5 by the water jet J is performed by means of the articulating tool 30, controlled by the control unit 40. The control unit 40 in particular controls the axes of rotation 30A and 30B. The control of these two axes of rotation thus allows positioning and orienting the injection nozzle 12, and therefore the water jet J, relative to the surface 5A.

The method can include a third step (step S3) of polishing the portion of the surface of the blade 4 on which the leading edge 5 was fixed, after completion of step S2. This polishing can be performed by manual or mechanized sanding. This step S3 allows cleaning the residual glue joint on the blade 4, in order to find a level of roughness close to that of the new part, and thus fix a new leading edge 5 on the blade 4.

The method described above presents one embodiment according to which the removal of the leading edge is performed by a scanning of the surface 5A by the nozzle 12 moving at a constant speed v0, the pressure p of the water jet varying as a function of the position on the surface 5A, and based on the conversion performed by the control unit 40. However, other embodiments can be envisaged.

For example, during step S2, the control unit 40 can convert the thicknesses measured during step S1, into speeds v of displacement of the nozzle 12. The step of removing the leading edge is thus performed by a scanning of the surface 5A by the nozzle 12 at a constant pressure p0, the nozzle 12 moving at a speed varying as a function of the position on the surface 5A, and based on the conversion performed by the control unit 40.

According to another example, both the speed of displacement of the nozzle 12 and the pressure of the water jet J can vary as a function of the thickness of the leading edge 5. To do so, the thicknesses determined in step S1 are converted into a speed/pressure pair (v, p).

According to yet another example, the removal step can also be carried out at constant speed and pressure. To do so, the removal thicknesses determined in step S1 are converted into a number of passes, that is to say the number of required passages of the water jet J, at constant speed v0 and pressure p0, for a given point of the surface 5A, as a function of the thickness of the leading edge 5 at this point.

Although the present invention has been described with reference to specific exemplary embodiments, it is clear that modifications and changes can be made to these examples without departing from the general scope of the invention as defined by the claims. Particularly, individual characteristics of the different illustrated/mentioned embodiments can be combined in additional embodiments. Consequently, the description and the drawings should be considered in an illustrative rather than restrictive sense.

It is also clear that all the characteristics described with reference to a method can be transposed, alone or in combination, to a device, and conversely, all the characteristics described with reference to a device can be transposed, alone or in combination, to a method.

1. A method for removing a leading edge fixed to a fan blade, the fan blade comprising a first material, and the leading edge comprising a second material different from the first material, the method comprising steps of:
Determining the thicknesses of the leading edge as a function of the position on the leading edge
Removing the leading edge by means of a pressurized water jet moving over the leading edge as a function of the thicknesses determined in the determination step.

2. The method according to claim 1, wherein the first material is an organic matrix composite, and the second material is a metal.

3. The method according to claim 1, wherein the pressure of the water jet is comprised between 100 and 1,000 bars.

4. The method according to claim 1, wherein the injected water includes an abrasive media.

5. The method according to claim 1, wherein the water jet is applied by means of a nozzle oriented so as to form an angle comprised between +/−15° and +/−25°, preferably equal to +/−20° relative to a normal to a plane tangent to the surface of the leading edge at a point on which the water jet is applied.

6. The method according to claim 1, wherein the determination of the thicknesses of the leading edge as a function of the position on the leading edge is performed via ultrasound.

7. The method according to claim 1, wherein during the removal step, the speed of displacement of the water jet moving over the leading edge is constant, and the pressure of the water jet varies as a function of the thickness to be removed.

8. The method according to claim 1, wherein during the removal step, the speed of displacement of the water jet moving over the component varies as a function of the thickness to be removed, the pressure of said water jet being constant.

9. The method according to claim 1, wherein a suction tool sucks the material removed during the removal step.

10. The method according to claim 1, wherein the water jet moves over the leading edge by means of an articulating tool comprising at least two axes of rotation.

11. The method according to claim 1, comprising, after the removal step, a step of polishing the fan blade resulting from the removal step.

12. A device for removing a leading edge fixed to a fan blade, the fan blade comprising a first material, and the leading edge comprising a second material different from the first material, the removal device comprising a measuring tool configured to measure the thickness of the leading edge as a function of the position on the leading edge, and a pressurized water injection tool configured to remove the leading edge by means of the pressurized water jet moving over the leading edge, as a function of the thicknesses determined by the measuring tool.
